(19) United States
(12) Patent Application Publication
(10) Pub. No.: US 2020/0389074 A1
(43) Pub. Date: Dec. 10, 2020

(54) AIR PULSER FOR MOTOR VEHICLE

(71) Applicant: Valeo Systemes Thermiques, Le Mesnil-Saint-Denis Cedex (FR)

(72) Inventors: Maurad Berkouk, Le Mesnil Saint Denis (FR); Cyril Gontier, Le Mesnil Saint-Denis (FR); Julien Brault, Le Mesnil Saint Denis (FR); Dominique Bruin, Le Mesnil Saint Denis (FR)

(73) Assignee: Valeo Systemes Thermiques, Le Mesnil-Saint-Denis Cedex (FR)

(21) Appl. No.: 16/632,996

(22) PCT Filed: Jul. 25, 2018
(86) PCT No.: PCT/FR2018/051906

§ 371 Date: Jun. 26, 2020

(30) Foreign Application Priority Data
Jul. 26, 2017 (FR) 1757090

(51) Int. Cl. H02K 9/28; F04D 17/08; F04D 25/06; F04D 29/58; B60H 1/00; H02K 5/14; H02K 5/20; H02K 5/22; H02K 5/24; H02K 9/06

(52) U.S. Cl. CPC H02K 9/28; F04D 17/08; F04D 25/06; F04D 29/5806; H02K 9/06; H02K 5/145; H02K 5/20; H02K 5/225; H02K 5/24; B60H 1/00471

(57) ABSTRACT

The present invention concerns an air pulser (1) for a heating, ventilation and/or air conditioning device for a motor vehicle, according to which said air pulser (1) comprises: —an electric motor (10) comprising a drive shaft (100) and brushes (101) on which a wheel (11) is mounted; —said wheel (11) is capable of generating a main air flow (F1) in said heating, ventilation and/or air conditioning device; —a motor support (12) in which said electric motor (10) is housed and comprising an air channel (8) in which a secondary air flow (F2) from said main air flow (F1) is capable of circulating (F1), said air channel (8) comprising a first part (129) and a second part (144), said second part (144) comprising a curved shape so as to direct said secondary air flow (F2) onto said brushes (101) of said electric motor (10).

### TECHNICAL FIELD OF THE INVENTION

The present invention relates to an air blower for a heating, ventilating and/or air conditioning device for a motor vehicle.

It is particularly, but not limitatively, applicable in motor vehicles.

### TECHNOLOGICAL BACKGROUND OF THE INVENTION

An air blower for a heating, ventilating and/or air conditioning device for a motor vehicle, known to a person skilled in the art, comprises:
an electric motor comprising two brushes and on which a wheel is mounted;
said wheel, capable of generating a main air flow in said heating, ventilating and/or air conditioning device;
an air duct in which said main air flow can circulate, said main air flow being divided into two secondary air flows that each cool one of the two brushes of the electric motor.

Against this background, the present invention aims to offer an alternative solution to the aforementioned prior art.

### GENERAL DESCRIPTION OF THE INVENTION

To this end, the invention proposes an air blower for a heating, ventilating and/or air conditioning device for a motor vehicle, according to which said air blower comprises:
an electric motor comprising a drive shaft and brushes and on which a wheel is mounted;
said wheel, capable of generating a main air flow in said heating, ventilating and/or air conditioning device;
a motor support in which said electric motor is housed and comprising an air duct in which a secondary air flow originating from said main air flow is capable of circulating, said air duct comprising a first part and a second part, said second part comprising a curved shape so as to direct said secondary air flow onto said brushes of said electric motor.

Thus, as will be seen in detail below, the curved shape makes it possible to orient the main air flow in the direction of the brushes of the electric motor so that they are correctly cooled. Curved shape is given to mean any shape that has a curvature.

According to non-limitative embodiments, the air blower can also include one or more of the following additional features:

According to one non-limitative embodiment, said second part has a cavity oriented in the direction of said motor support.

According to one non-limitative embodiment, said electric motor also comprises commutators and said brushes are arranged in brush holders, and according to which said brushes and/or said brush holders and/or said commutators comprise openings. This makes it possible to facilitate the cooling of the brushes of the electric motor. This helps the secondary air flow to reach the brushes.

According to one non-limitative embodiment, the curved shape is a conic shape.

According to one non-limitative embodiment, the conic shape is a parabolic shape, an elliptical shape or a hyperbolic shape.

According to one non-limitative embodiment, the parabolic shape is an arc. This makes it possible to have a constant radius of curvature. A constant velocity of the secondary air flow F2 is thus maintained.

According to one non-limitative embodiment, said second part comprises a radius of between 29 and 45 millimeters. This range makes it possible for the secondary air flow F2 to follow the radius of curvature and to have a reasonable footprint. If the radius is too small, there is a risk that the secondary air flow F2 will not follow the radius of curvature. Of course, depending on the space available for the air blower, the radius can be larger.

According to one non-limitative embodiment, said second part comprises a tangent that forms an angle of between 45 degrees and 60 degrees with said drive shaft. The tangent depends on the position of the brushes of the electric motor to be cooled relative to the position of the edge at the end of the curved shape.

According to one non-limitative embodiment, said second part comprises a tangent that forms an angle of substantially 55 degrees.

According to one non-limitative embodiment, said second part comprises a radial distance of between 61 and 82 millimeters. This radial distance depends on the diameter of the wheel. To this end, in one non-limitative embodiment, the diameter of the wheel is substantially between 120 mm (millimeters) and 160 mm.

According to one non-limitative embodiment, the second part comprises a linear inner wall or an inner wall comprising a series of adjacent segments having different orientations. The adjacent segments make it possible to obtain a curvature in order to orient the secondary air flow in the direction of the brushes of said electric motor.

According to one non-limitative embodiment, said second part also comprises a sharp edge at one of its ends. This makes it possible for the secondary air flow F2 to detach from the wall of the second part and not continue its path following the wall of the motor support that follows on from the second part.

According to one non-limitative embodiment, said motor support comprises:
a motor cover capable of covering said electric motor on the side opposite said wheel and defining said second part of said air duct;
a base capable of defining said first part of said air duct.

The secondary air flow F2 travels in the first part of the air duct then in the second part to arrive at the brushes.

According to one non-limitative embodiment, said motor support also comprises partitions that extend from the motor cover in the direction of the brushes of said electric motor. This makes it possible to contain the secondary air flow around said brushes.

According to one non-limitative embodiment, each partition is arranged near a brush of said electric motor. In addition, the partition is situated upstream of the brush. In other words, the air stream meets the partition before it meets the brush of the electric motor. This makes it possible to deflect the secondary air flow F2 so that it is directed in the direction of the brushes. The secondary air flow F2 is not dispersed around the electric motor 10, but stays as close to the brushes as possible in order to cool them more effectively.

According to one non-limitative embodiment, said partitions are offset from each other relative to the drive shaft. This makes it possible to position said partitions behind each brush of the electric motor.

According to one non-limitative embodiment, said air blower also comprises:
a vibro-acoustic decoupling device comprising ribs; and
said motor cover comprises fingers capable of engaging with said ribs. This makes it possible to obtain a device for limiting radial movement, and axial movement in a given direction.

According to one non-limitative embodiment, said ribs are made from a thermoplastic elastomer and said fingers are made from a rigid material. This makes it possible to avoid impacts when said fingers and said ribs come into contact with each other.

### BRIEF DESCRIPTION OF THE FIGURES

The invention and the various applications thereof will be more clearly understood on reading the following description and examining the accompanying figures:

FIG. 1 diagrammatically shows a heating, ventilating and/or air conditioning device comprising an air blower according to one non-limitative embodiment of the invention;

FIG. 2 shows a perspective view of the air blower without the blower housing in FIG. 1 assembled according to one non-limitative embodiment of the invention, said air blower comprising an electric motor, a wheel and a motor support comprising an air duct;

FIG. 3 shows an exploded view of the air blower in FIG. 2 according to one non-limitative embodiment;

FIG. 4a shows a side view of an electric motor of the air blower in FIG. 3 according to one non-limitative embodiment;

FIG. 4b shows a top view of the electric motor in FIG. 4a;

FIG. 5 shows a top view of a wheel of the air blower in FIG. 3 according to one non-limitative embodiment;

FIG. 6 shows a side view of the electric motor-wheel assembly in FIGS. 4 and 5;

FIG. 7a shows a top view of a base of the motor support in FIG. 3 without a vibro-acoustic device, according to one non-limitative embodiment, said base defining a first part of an air duct;

FIG. 7b shows a top view of a base of the motor support in FIG. 3 with a vibro-acoustic device, according to one non-limitative embodiment;

FIG. 7c shows a perspective view of the base in FIG. 7b according to one non-limitative embodiment;

FIG. 7d shows a top view of the electric motor in FIG. 4 assembled in the base of the motor support in FIGS. 7b and 7c according to one non-limitative embodiment;

FIG. 8a shows a side view of a motor cover of the motor support in FIG. 3 according to one non-limitative embodiment, the motor cover defining a second part of the air duct;

FIG. 8b shows a perspective view of the bottom of the motor cover in FIG. 8a according to one non-limitative embodiment;

FIG. 8c shows a cross-sectional view of the motor cover in FIGS. 8a and 8b according to one non-limitative embodiment;

FIG. 8c shows a cross-sectional view of the motor cover in FIGS. 8a and 8b according to one non-limitative embodiment;

FIG. 8d shows a cross-sectional view of the motor cover in FIGS. 8a to 8c according to one non-limitative embodiment, the motor cover engaging with the electric motor in FIG. 4;

FIG. 9a is a diagram of the motor cover in FIGS. 8a to 8d illustrating the path of a secondary air flow when the second part of the air duct delimited by the motor cover in FIGS. 8a to 8d comprises a sharp edge and a linear inner wall;

FIG. 9b is a diagram of a second part of the motor cover in FIGS. 8a to 8d illustrating the path of a secondary air flow when the motor cover comprises partitions, said second part comprising a linear inner wall;

FIG. 9c is a diagram of a second part of the motor cover in FIGS. 8a to 8d illustrating the path of a secondary air flow when the motor cover comprises partitions, said second part comprising a segmented inner wall;

FIG. 10a is a cross-sectional view of the motor cover in FIG. 3 according to one non-limitative embodiment, said motor cover comprising stops; and

FIG. 10b is a cross-sectional view of the motor cover in FIG. 10a according to one non-limitative embodiment, said motor cover engaging with a vibro-acoustic device.

### DESCRIPTION OF EMBODIMENTS OF THE INVENTION

Structurally or functionally identical elements appearing in different figures have the same reference signs unless otherwise specified.

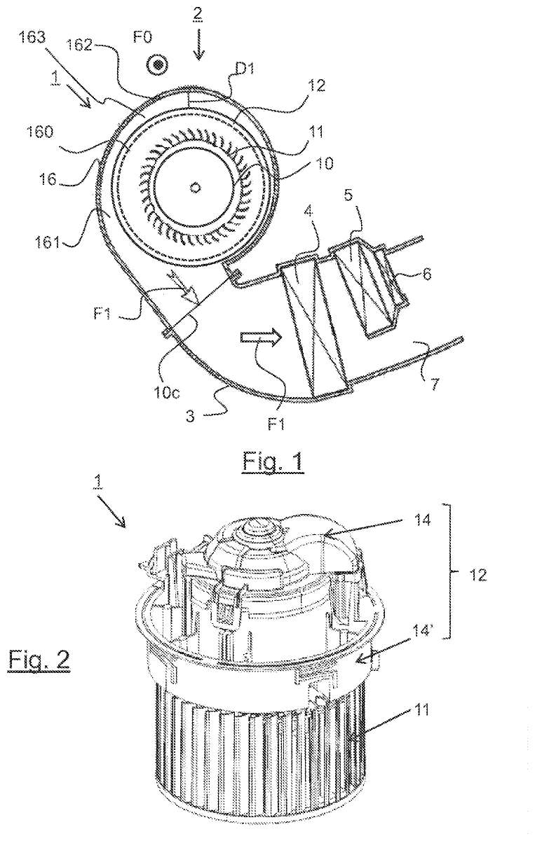

The air blower 1 for a motor vehicle is described with reference to FIGS. 1 to 10b according to one non-limitative embodiment.

Motor vehicle is given to mean any type of powered vehicle.

In one non-limitative embodiment, an air blower 1 is used in a heating, ventilating and/or air conditioning (HVAC) device 2, for a motor vehicle.

In the description below, the heating, ventilating and/or air conditioning device 2 is also called an HVAC device.
The HVAC device is diagrammatically illustrated in FIG. 1. It comprises:
an air blower 1 delivering an air flow F1 into an air duct 3;
said air duct 3;
an evaporator 4 of a coolant circuit (when the air conditioning function is present) arranged in the air duct 3;
a liquid heat exchanger heat sink 5 arranged in the air duct 3 and passed through by a coolant of the electric motor of the motor vehicle; and
optionally, an additional electric heat sink 6 arranged in the air duct 3.
   Hereinafter, the air flow F1 will also be called the main air flow F1.
   In air conditioning mode, the air flow F1 is diverted into a passage 7 in parallel with the heat sink 5. Downstream of the heat sinks 5 and 6, the air duct 3 distributes the air flow F1 towards vent outlets in the interior of the motor vehicle. The distribution and optionally the mixing of the air flow F1 are carried out using controlled flaps (not illustrated). The mixing enables the temperature regulation of the air flow F1 before distribution in the car interior. The distribution and mixing are known to a person skilled in the art and are not described here.
   In the description below, the air duct 3 is also called the main air duct 3.
   In a first non-limitative embodiment illustrated in FIG. 1, the HVAC device also comprises a blower housing 16 and the air blower 1 does not comprise said blower housing 16.
   In a second non-limitative embodiment not illustrated, the HVAC device comprises a part of the blower housing 16 and the air blower 1 comprises a part of the blower housing 16. In particular, the motor support 12 (described below) of the air blower 1 is configured so as to define part of the blower housing 16 that complements the other part of the blower housing 16 comprised in the HVAC device. The motor support 12 thus comprises a wall that is the part of the blower housing 16 that complements the other part of the blower housing 16 comprised in the HVAC device. This complementary part of the blower housing 16 is known to a person skilled in the art and is not described here.

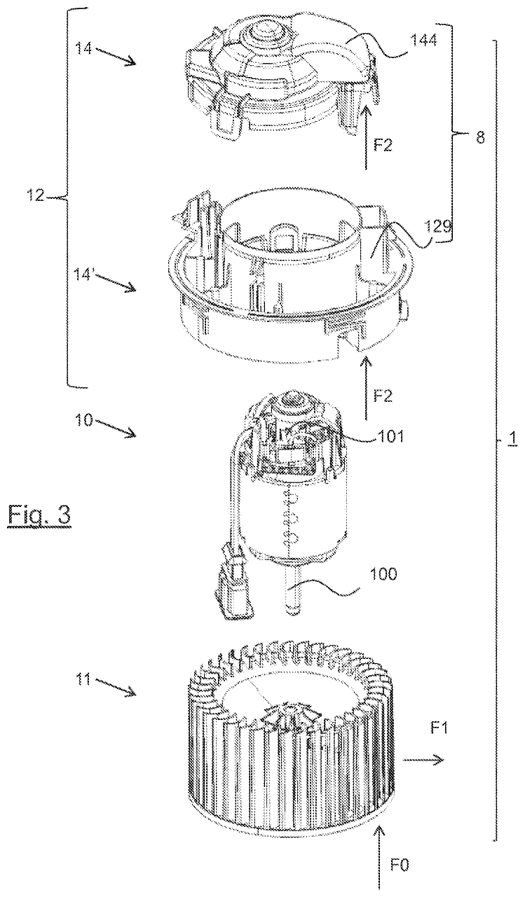

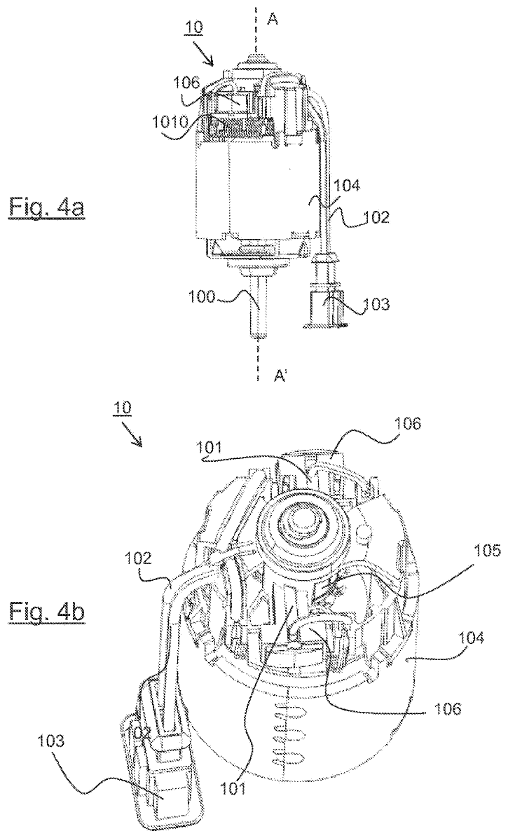

FIGS. 2 and 3 illustrate an air blower 1 of the HVAC device without the blower housing 16 according to one non-limitative embodiment, in an assembled view and an exploded view respectively.

The air blower 1 includes:
an electric motor 10 comprising a drive shaft 100 and brushes 101 and on which a wheel 11 is mounted;
said wheel 11, capable of generating a main air flow F1 in said HVAC device;
a motor support 12 in which said electric motor 10 is housed and comprising an air duct 8 in which a secondary air flow F2 originating from the main air flow F1 is capable of circulating.
   In other words, part of the air flow generated by the rotation of the wheel 11 travels along the secondary air duct 8 and thus forms the secondary air flow F2.
   In one non-limitative embodiment, the air blower 1 is arranged under the dashboard of the motor vehicle, on the passenger side.
   The different elements of the air blower 1 are described in detail below, after the description of the blower housing 16 below.

Blower Housing 16

The blower housing 16 is illustrated in a top view in FIG. 1.
The blower housing 16 is a fixed part in the air blower 1. It is capable of guiding the main air flow F1 in the HVAC device.
It is capable of accommodating the wheel 11.
It comprises an inner wall 162. On one of its sides 161, the blower housing has an opening 160 (illustrated in dotted lines in FIG. 1) in which the motor support 12 is fastened. The motor support 12 defines a recess for the electric motor 10. The side (not illustrated) opposite the side 161 has an opening for taking in an incoming air flow F0. An incoming air flow F0 illustrated in FIG. 1 is sucked axially into the blower housing 16 and is circulated in the blower housing 16 to give the main air flow F1 and the latter is extracted from the blower housing 10 by an outlet 10c connected to the main air duct 3. The main air duct 3 is delimited by the blower housing 16.
In one non-limitative embodiment, the flow rate of the main air flow F1 is between 100 kg/hr and 600 kg/hr.

Electric Motor 10

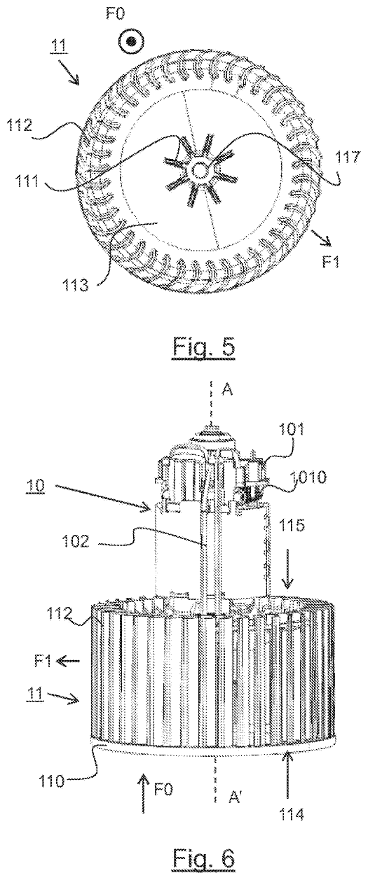

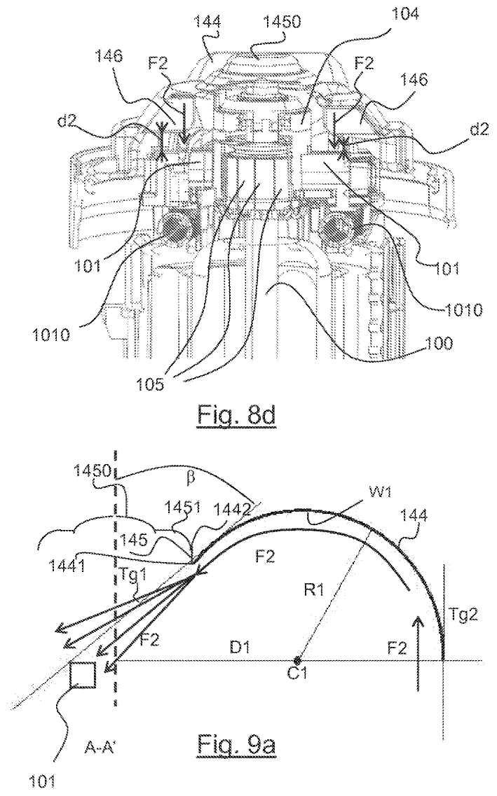

The electric motor 10 is illustrated in FIGS. 4a, 4b and 8d.
It is capable of rotating the wheel 11.
The electric motor 10 protrudes laterally on the side 161 of the blower housing 16. It is housed in the motor support 12 and is capable of being fastened to the motor support 12.
It includes a drive shaft 100 on which the wheel 11 is mounted. The drive shaft 100 defines an axis A-A′ of rotation of the wheel 11 and assembly of the elements of the air blower 1. This axis A-A′ is also called the motor axis A-A′ hereinafter. The drive shaft 100 is capable of being fitted into the hub 117 of the wheel 11.
The electric motor 100, which is capable of moving, is fastened to an inner ring 124′ of the base 14′ of the motor support 12 described below.
In one non-limitative embodiment, the electric motor 10 also includes:
a rotor (not illustrated) and a stator 104;
at least two brushes 101 (illustrated in FIGS. 4b and 8d);
a harness 102 (illustrated in FIGS. 4a, 4b and 8d) for electrical connection to a control module (not illustrated), said electrical connector harness 102 comprising a connector 103 for said connection and enabling the supply of power to the electric module 10. The electric motor 10 is thus powered by a battery of the motor vehicle via the control module.
   The electric motor 10 also includes:
brush holders 106 (illustrated in FIGS. 4a and 4b) in which the brushes 101 are arranged. In one non-limitative embodiment, the brush holders 106 are made from plastic;
commutators 105 (illustrated in FIGS. 4b and 8d). The commutators 105 are rotary commutators. They are capable of creating an electric connection between the stator and the rotor 104. The brushes 101 are in contact with said commutators 105.
   The brushes 101 are each connected to an inductor 1010.
   It will be noted that in embodiments known to a person skilled in the art, the control module is installed in the actual body of said blower housing 16, in the base 14′ of the motor support 12 on the outer side of said motor support 12, on the motor cover 14 of the motor support 12, or at a distance from the motor support 12. The control module comprises a PCBA (Printed Circuit Board Assembly) on which electronic components are arranged. It will be noted that the PCBA is single-sided or double-sided, that is, it includes electronic components on a single side or on both sides. The control module is capable of controlling the electric motor 10 of the air blower 1. On the basis of a power setpoint, the control module regulates the speed of the electric motor 10 in order to obtain the desired power. Said regulation is carried out via the control of the current in said electric motor 10. To this end, the control module comprises control elements that are switches such as, in a non-limitative example, MOSFET transistors, and that are capable of controlling the current in said electric motor 10. Such control is known to a person skilled in the art and is not described here.
   The operation of an electric motor 10 is also known to a person skilled in the art and is not described here.
   As will be seen below, the electric motor 10, in particular the brushes 101 thereof, is cooled by the secondary air flow F2 that circulates in the secondary air duct 8. The electric motor 10 heats up when it is operating and it is therefore necessary to cool it, in particular its brushes 101, so as to avoid overheating.
   In one non-limitative embodiment, the brushes 101 and/or the brush holders 106 and/or said commutators 105 comprise openings. This facilitates the cooling of the brushes 101. The secondary air flow F2 (described below) will be able to pass through said openings in order to reach said brushes 101. This thus contributes to improved cooling of the brushes 101.

Wheel 11

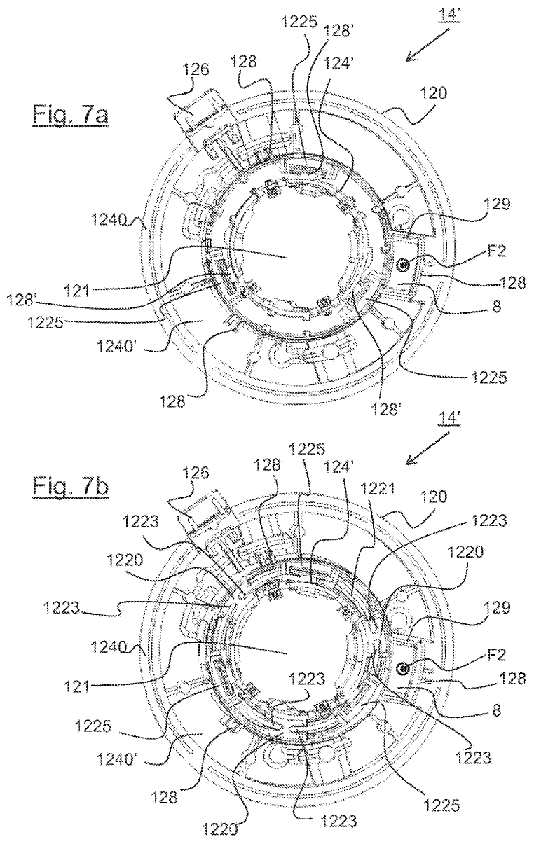

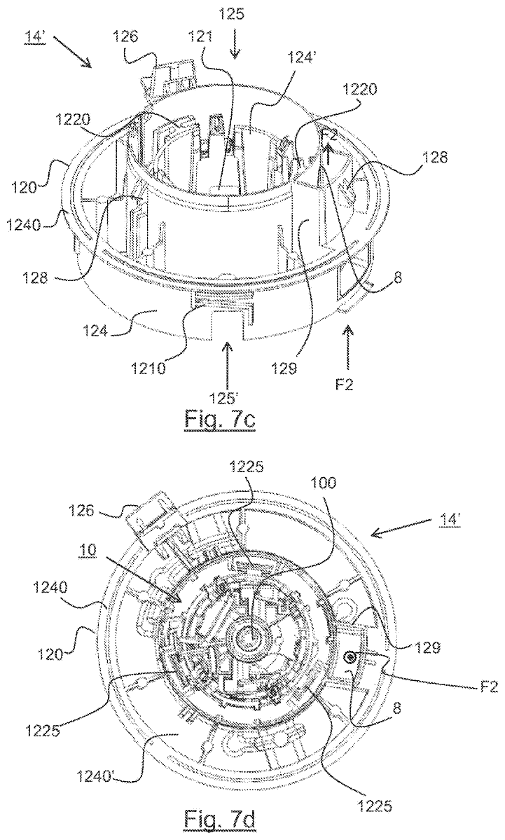

The wheel 11 is illustrated in a top view in FIG. 5 and a side view in FIG. 6.
The wheel 11 is a movable part in the air blower 1.
The wheel 11 is a centrifugal wheel that is capable of rotating about the motor axis A-A′. It is rotated by said electric motor 10. It is capable of axially sucking an incoming air flow F0 into the blower housing 16, circulating it in said blower housing 16 and generating the main air flow F1. The latter leaves the blower housing 16 radially, that is, orthogonally to the motor axis A-A′ as illustrated in FIG. 5. It will be noted that the incoming air flow F0 is situated under the wheel 11.
The wheel 11 is housed inside the blower housing 16.
The wheel 11 includes:
a hub 117 capable of accommodating the drive shaft 100 of the electric motor 10;
a bowl 113 connecting the hub 117 to the blades 112. In one embodiment not illustrated the bowl 113 is closed, that is, it does not comprise any arms or openings.
reinforcing ribs 111 of the hub 117;
blades 112.
   The wheel 11 includes a periphery 110 that is smaller than the periphery 120 of the motor support 12 described below.
   As illustrated in FIG. 6, the wheel 11 is mounted on the electric motor 10. The wheel 11 and the electric motor 10 are coaxial along the motor axis A-A′. This makes it possible to maximize the compactness of the assembly.
   In one non-limitative embodiment, the wheel 11 comprises a diameter of between 120 mm and 160 mm. In one non-limitative embodiment, its height is between 40 mm and 85 mm.

Motor Support 12

The motor support 12 comprises two parts: a first part that is a motor cover 14 and a second part that is a base 14′. The motor cover 14 is arranged on said base 14′. In one non-limitative embodiment illustrated, the motor cover 14 and the base 14′ are two separate parts. The motor cover 14 is thus detachable from the base 14′.
In another non-limitative embodiment not illustrated, the motor cover 14 and the base 14′ can be molded together so that they form a single part. The motor cover 14 is thus rigidly connected to the base 14′ and is not detachable from said base 14′.
In one non-limitative embodiment, the motor support 12 is made from rigid plastic. In one non-limitative example, the motor support 12 is made from polypropylene.

Base 14′

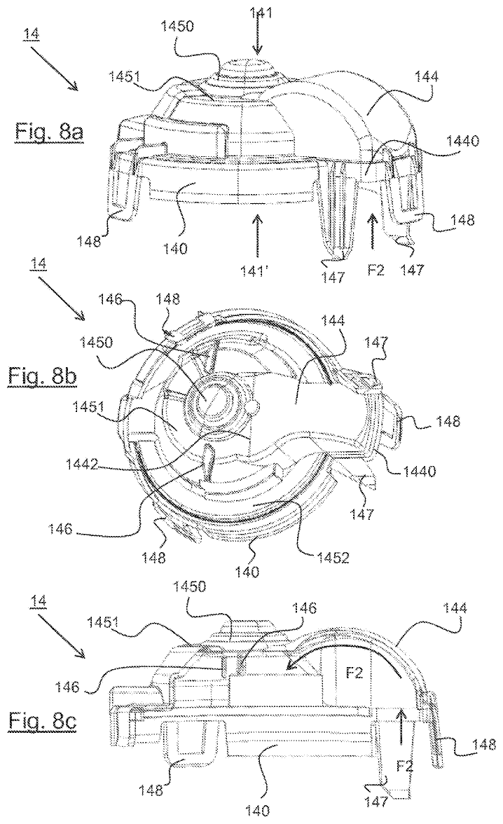

The base 14′ of the motor support 12 is illustrated in FIGS. 7a to 7d.
It is capable of being inserted into the opening 160 situated on the side 161 of the blower housing 16 and being fastened to said blower housing 16. It is not closed. In one non-limitative embodiment, the base 14′ of the motor support 12 is coaxial with the electric motor 10 and the wheel 11. It is not axially offset relative to the wheel 11, which makes it possible to maximize the compactness of the assembly.
The base 14′ includes a periphery 120 that is larger than the periphery 110 of the wheel 11. This makes it possible to axially cover the wheel 11 and to assemble the wheel 11-base 14′ assembly of the motor support 12 on the blower housing 16.

As illustrated in FIGS. 7a to 7d, in one non-limitative embodiment, the base 14′ comprises:
a recess 121 capable of accommodating the electric motor 10, in particular the stator 104 and the electrical connector harness 102. FIG. 7d illustrates the electric motor 12 in said recess 121 and mounted on the base 14′ of the motor support 12;
an outer ring 124 (illustrated in FIG. 7c). It includes a collar 1240 that defines the periphery 120;
an inner ring 124′ with a smaller diameter than the outer ring 124. Said inner ring 124′ makes it possible to clasp said electric motor 10 so as to prevent it from translating and rotating relative to the base 14′ of the motor support 12.
   The outer ring 124 comprises an inner cylindrical base 1240′ that connects the outer ring 124 and the inner ring 124′. The motor cover 14 can rest partially on this inner cylindrical base 1240′.

In one non-limitative embodiment, the base 14′ also includes:
a device 126-1210 for fastening to the blower housing 16 (illustrated for example in FIG. 7d);
a device 128-128′ (illustrated in FIGS. 7a and 7b) for attaching to the motor cover 14;
at least one rigid stop 1225 (illustrated in FIGS. 7a and 7b) that limits the radial and axial movement of the inner ring 124′ (and as a result the movement of the electric motor 10) relative to the outer ring 124 in all directions.
   The fastening device is a bayonet fastening 126-1210. It makes it possible to fasten the motor support 12 on the side 161 of the blower housing 16 by translation and a quarter-turn rotation. To this end, in one non-limitative embodiment, the bayonet fastening device comprises a clip 126 and two handles 1210 that engage with complementary elements (not illustrated) in the blower housing 16. The clip 126 protrudes axially from the collar 1240.
   In one non-limitative embodiment, the attaching device 128-128′ comprises at least one outer wedge 128 for fastening the motor cover 14 and at least one inner fastening wedge 128′.
   The outer fastening wedge 128 is capable of engaging with a fastening device 148 belonging to the motor cover 14 described below.
   In the non-limitative example illustrated, the base 14′ of the motor support 12 comprises three outer fastening wedges 128 and three inner fastening wedges 128′ as illustrated in FIG. 7a.
   The outer 128 and inner 128′ fastening wedges are molded respectively on the outside and inside of the inner ring 124′.
   The rigid stop 1225 is capable of engaging with an inner fastening wedge 128′ of the inner ring 124′ of the base 14′. Said rigid stop 1225, with the periphery 140, is capable of sandwiching the inner ring 124′ of the base 14′. In the non-limitative example illustrated, there are three rigid stops 1225.
   The rigid stops 1225, in combination with the inner fastening wedges 128′, thus form a movement limiting device that is rigid.

In one non-limitative embodiment, the base 14′ of the motor support 12 also comprises a vibro-acoustic decoupling device 1220 illustrated in FIG. 7b between the inner ring 124′ and the outer ring 124 of the motor support 12 capable of preventing vibrations (due to the rotation of the electric motor 10 and the wheel 11) from being transferred to the outer ring 124 and as a result to the HVAC device. There is thus no rigid contact between the inner ring 124′ and the outer ring 124. In one non-limitative embodiment, this vibro-acoustic decoupling device 1220 is made from a thermoplastic elastomer (TPE) and overmolded. More particularly, in one non-limitative variant, the thermoplastic elastomer is SEBS (polystyrene-b-poly(ethylene-butylene)-b-polystyrene). SEBS has a low percentage of polypropylene (PP) which results in the very strong adhesion of the material on PP, that is, on the outer ring 124 and the inner ring 124′, which are made from polypropylene in one non-limitative example.

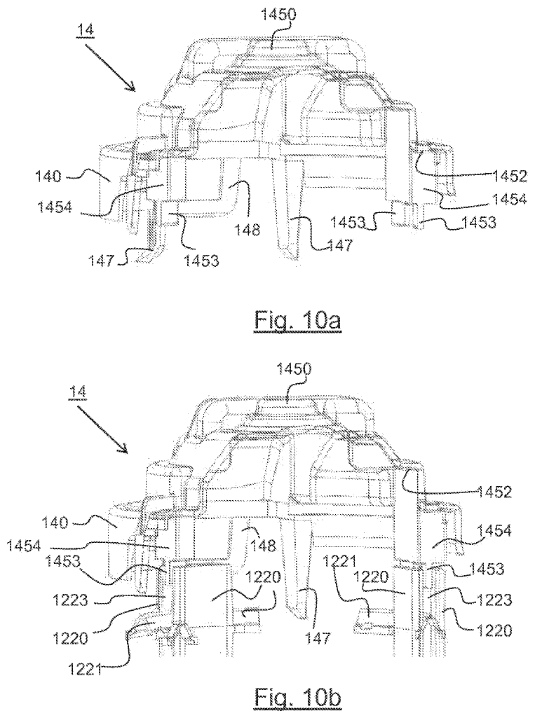

In one non-limitative embodiment, the vibro-acoustic decoupling device 1220 consists of studs connected or not by a diaphragm 1221 (illustrated in FIGS. 7b and 10b) also made from a thermoplastic elastomer TPE. In one non-limitative example illustrated, there are three studs 1220.

The base 14′ is capable of partially defining an air duct 8, that is, a first part 129 of said air duct 8 as illustrated in FIGS. 3 and 7a to 7d. To this end, in one non-limitative embodiment the base 14′ comprises axial walls 129 that partially define the air duct 8. The latter is also called the secondary air duct 8 hereinafter. In one non-limitative example, the walls 129 are substantially flat. They thus define a first part of the secondary air duct 8.

The secondary air duct 8 is capable of diverting, from a main air flow F1, a secondary air flow F2 so that the latter can cool the electric motor 10, in particular the brushes 101 thereof.
The secondary air flow F2 circulates in this first part 129 of the secondary air duct 8 parallel to the motor axis A-A′ of the electric motor 10 as illustrated in FIGS. 7a to 7d. It therefore circulates axially at the start. It is thus orthogonal to the main air flow F1.

In one non-limitative embodiment, the secondary air flow F2 has an air flow rate of 10 kg/hr.

It will be noted that the base 14′ of the motor support 12 is open on both sides so that:
the electric motor 10 can be mounted in its recess 121;
the brushes 101 of the electric motor 10 extend on one side 125 beyond the outer ring 124 of the motor support 12; and
the drive shaft 100 extends on the other side 125′ beyond the inner cylindrical base 1240′ of the outer ring 124.

Motor Cover 14

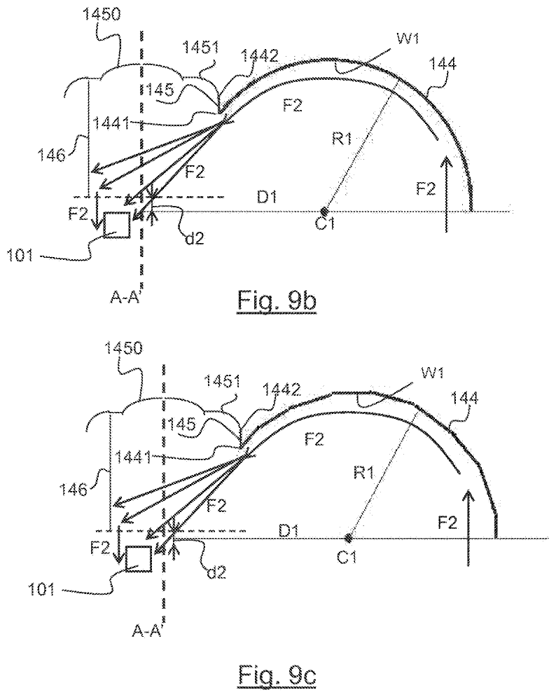

The motor cover 14 is illustrated in FIGS. 8a to 9b.
It is capable of:
being arranged on the electric motor 10 so that it covers the part of the electric motor 10 opposite the wheel 11; and
partially defining the secondary air duct 8, that is, a second part 144 of said secondary air duct 8.
   In one non-limitative embodiment, the motor cover 14 comprises a periphery 140 that is smaller than the periphery 120 of the base 14′ of the motor support 12. The base 14′ of the motor support 12 thus comprises the largest diameter of the elements (electric motor 10, motor cover 14, wheel 11) of the air blower 1.
   The motor cover 14 therefore comprises:
a periphery 140;
an outer face 141, that is, which is facing the outside of the blower housing 16.

The outer face 141 is the face furthest from the wheel 11;
an inner face 141′, that is, which is facing the inside of the blower housing 16 on the wheel 11 side, and therefore towards the electric motor 10.
   The motor cover 14 is fastened to the base 14′ of the motor support 12.
   In one non-limitative embodiment, the motor cover 14 also comprises:
a fastening device 148 capable of engaging with the attaching device 128 seen above, the assembly making it possible to fasten the motor cover 14 to the base 14′;
at least one guiding tab 147 capable of resting on the inner cylindrical base 1240′.

The motor cover 14 is capable of protecting the electric motor 10 against dust or splashes of liquid. As illustrated in FIG. 8a, in one non-limitative embodiment, the motor cover 14 is completely closed, that is, the outer face 141 thereof is completely closed so that it protects the electric motor 10 against dust or splashes of liquid such as, in a non-limitative example, water. It comprises a cap 1450 that is situated on the motor axis A-A′, and a bottom 1451 on which the cap 1450 rests and that is joined to the second part 144 of the secondary air duct 8. The joint has the reference sign 1442 in FIG. 8b and in FIGS. 9a and 9b.

As illustrated in FIGS. 8a to 8c, the secondary air duct 8 is partially defined by a wall 144 in the motor cover 14 that defines the second part of the secondary air duct 8. Said second part 144 protrudes partially radially relative to the periphery 140. It extends radially to the edge of said periphery 140. It thus comprises a base 1440 orthogonal to the walls 129 defining the first part of the secondary air duct 8 and therefore orthogonal to the motor axis A-A′.
The second part 144 is open (that is, the base 1440 thereof is open) on the side of the periphery 140 so that the secondary air flow F2 that comes from the first part 129 can arrive in said second part 144. The secondary air flow F2 thus arrives axially on this wall 144 (FIGS. 8a, 8c, 9a and 9b) via the first part 129.
In one non-limitative embodiment, the second part 144 comprises a curved shape so that it directs the secondary air flow F2 onto the brushes 101 of the electric motor 10. This shape does not generate any pressure drop, compared to an additional part that would reduce the velocity of the secondary air flow F2 in order to make it change direction. The curved shape thus does not slow the velocity of the secondary air flow F2. Curved shape is thus given to mean any shape that has a curvature.
The curved shape can thus comprise a linear inner wall W1 (illustrated in FIGS. 9a and 9b) or a segmented inner wall W1 (illustrated in FIG. 9c). In the latter case, the inner wall W1 comprises a series of adjacent segments having different orientations so that a curvature is obtained in order to orient the secondary air flow F2 in the direction of the brushes 101 of the electric motor 10. The second part 144 thus comprises a series of segments arranged according to a curved profile.
The second part 144 has a cavity oriented in the direction of the motor support 12. Thus, the entire secondary air flow F2 will bend towards the motor support 12, in particular towards the brushes 101 thereof.
The secondary air duct 8 is also partially delimited by two facing walls that extend transverse to the inner wall W1. In other words, the two facing walls form side walls of the secondary air duct 8 and the inner wall W1 forms a bottom wall of the secondary air duct 8.
The secondary air duct 8 is contained entirely between two planes parallel to the motor axis A-A′, the motor axis A-A′ being arranged between these two parallel planes. According to one embodiment, the distance between these two parallel planes is between a value equal to 25% of the diameter of the motor cover 14 and a value equal to 70% of the diameter of the motor cover 14.
In one non-limitative embodiment, the curved shape is a conic shape. In non-limitative variants, the conic shape is a parabolic shape, an elliptical shape or a hyperbolic shape.
In one non-limitative example, the parabolic shape is an arc.
Thus, as can be seen in FIGS. 8a to 8c, in one non-limitative example, the second part 144 is arc-shaped. The second part 144 of the secondary duct 8 is thus rounded so that it orients the secondary air flow F2 in the direction of the brushes 101.
FIG. 9a diagrammatically illustrates the arc-shaped second part 144. As can be seen, the arc has:
an inner wall W1;
a radius R1;
a tangent Tg1 to said drive shaft 100, that is, to said axis A-A′; and
a radial distance D1 between the drive shaft 100 (that is, the motor axis A-A′) and the outside of the air duct 8, that is, the tangent Tg2 to the first part 129 of the air duct 8.
   As can be seen in FIGS. 9a and 9b, due to the arc-shaped second part 144, the secondary air flow F2 makes a turn to move along the inner wall W1 of the arc and arrive at the brushes 101 of the electric motor 10. The secondary air flow F2 is thus capable of cooling the brushes 101 of the electric motor 10.
   The tangent Tg1 is defined by the direction of the straight line tangent to the profile of the second part 144 at the end of the inner wall W1. The profile is taken in the mid-plane of the air duct 8 passing through the motor axis A-A′. The air circulating in the air duct 8 leaves the duct with a direction of flow corresponding to the tangent Tg1. The tangent Tg1 is directed towards the outer corner of the brushes 101 as illustrated in FIG. 9a.
   In one non-limitative embodiment, the radius R1 is between 29 and 45 mm (millimeters). In one non-limitative embodiment, the radius R1 is 29.35 mm.
   In one non-limitative embodiment, the tangent Tg1 is between 45 degrees and 60 degrees. In other words, the tangent Tg1 forms an angle of between 45 degrees and 60 degrees with the axis of the motor. As it travels along the second part 144, the secondary air flow F2 thus undergoes a change in its direction of flow that is between 120° and 135°.
   In one non-limitative variant, the tangent Tg1 is between 50 degrees and 55 degrees. In one non-limitative example, the tangent Tg1 is substantially 55 degrees. In these variants, the tangent Tg1 forms an angle with the motor axis A-A′ that is between 50 and 55 degrees or 55° respectively.
   In one non-limitative embodiment, the radial distance D1 is between 61 mm and 82 mm. In one non-limitative variant, the radial distance D1 is 61 mm.
   With these values, the secondary air flow F2 is correctly directed towards the brushes 101 so that correct cooling of said brushes 101 is obtained.
   There is thus no loss of secondary air flow F2 near the electric motor 10. The secondary air flow F2 does not remain at the bottom 1451 of the motor cover 14 but is correctly directed towards the brushes 101.
   It will be noted that the values of the radius R1, the tangent Tg1 and the radial distance D1 can apply to any type of curved shape other than an arc.

In one non-limitative embodiment illustrated in FIG. 9a, the second part 144 also comprises a sharp edge 145 at one end 1441 of the arc. The end 1441 is the end closest to the motor cover 14. The sharp edge 145 is connected to the bottom 1451 of the motor cover 14. This sharp edge 145 makes it possible to detach the secondary air flow F2 from the wall of the motor cover 14, which optimizes the orientation of said secondary air flow F2 in the direction of the brushes 101, unlike a rounded shape that could replace this sharp edge 145.

According to one embodiment, the sharp edge 145 is straight. The motor axis A-A′ and the axis of the sharp edge 145 are not aligned. According to one embodiment, the sharp edge 145 extends along an axis perpendicular to the motor axis A-A′. According to one embodiment, the distance between the sharp edge 145 and the motor axis A-A′ is between a value equal to 20% of the radial distance D1 and a value equal to 40% of the radial distance D1.

In one non-limitative embodiment illustrated in FIGS. 8b to 8d, the motor support 12 also comprises partitions 146 that extend from the motor cover 14 on the inner face thereof in the direction of the brushes 110 of the electric motor 10. In one non-limitative embodiment, there are as many partitions 146 as there are brushes 101, one partition 146 being associated with one brush 101.

The partitions 146 are distributed on either side of the cap 1450 and extend from the bottom 1451 of the motor cover 14 in an axial direction. As illustrated in FIGS. 8d and 9b, this forces the secondary air flow F2 to change direction (after the arc-shaped second part 144). The secondary air flow F2 is deflected by said partitions 146 so that it is directed axially downwards in the direction of the brushes 101. Due to the partitions 146, the motor cover 14 closes part of the volume situated behind the brushes 101. This prevents the loss of part of the secondary air flow F2 around the electric motor 10. The secondary air flow F2 stays around the brushes 101.
In one non-limitative embodiment, the partitions 146 are arranged near the brushes 101 relative to the drive shaft 100, that is, behind the brushes 101, the brushes 101 being closer to the motor axis A-A′ than the partitions 146. In other words, the brushes 101 are situated radially between the partitions 146 and the motor axis A-A′. According to one embodiment, the distance between the partitions 146 and the corresponding brushes 101 is less than 10 millimeters. As illustrated in FIGS. 8d and 9b, at the end 1441 of the second part 144, the secondary air flow F2 thus arrives behind the brushes 101 of the electric motor 10. Thus, part of the air flow striking the partitions 146 is reoriented towards the brushes 101. The brushes 101 are thus better cooled. It will be noted that the brushes 101 of the electric motor 10 are offset from each other relative to the drive shaft 100 (and therefore relative to the motor axis A-A′) by 180 degrees or 90 degrees depending on the topology of the electric motor. In one non-limitative embodiment, the partitions 146 are therefore offset relative to each other so that each partition 146 is arranged near one of the brushes 101. In addition, each partition 146 is situated upstream of each of the corresponding brushes 101. Thus, due to these partitions 146, the secondary air flow F2 is as close as possible to the brushes 101 so that the latter are better cooled.

In one non-limitative embodiment illustrated in FIGS. 10a and 10b, the motor cover 14 also comprises fingers 1453 capable of engaging with ribs 1223 of the vibro-acoustic device 1220. In particular, they are capable of being inserted into said ribs 1223 as illustrated in FIG. 10b. The fingers 1453 extend from the base 1452 of the motor cover 14 in an axial direction. In one non-limitative embodiment, the fingers 1453 are made from a rigid material while the ribs 1223 are made from a thermoplastic elastomer TPE. This makes it possible to avoid impacts when said fingers and said ribs 1223 come into contact with each other. In one non-limitative embodiment, the fingers 1453 are made from rigid plastic. In one non-limitative variant, they are made from polypropylene.

The ribs 1223 are located on the studs 1220 illustrated in FIG. 7b. There are two ribs 1223 per stud so that the fingers 1453 are inserted on each side of the studs 1220. The fingers 1453 enable the vibro-acoustic device 1220 to not break during vibration resistance tests. The fingers 1453 prevent the radial and axial movement of the studs 1220. The finger 1453-rib 1223 assembly absorbs the kinetic energy that occurs during these vibration resistance tests.
In addition, the fingers 1453, in combination with the ribs 1223, limit:
the radial movement of the electric motor 10 and the inner ring 124′; and
the axial movement of the electric motor 10 and the inner ring 124′ in one direction, which is the direction in which the electric motor 10 moves towards the motor cover 14.
   The fingers 1453, in combination with the ribs 1223, thus form a movement limiting device that is flexible.
   Due to this flexible movement limiting device and to the rigid movement limiting device (1225-128′) seen previously, the axial and radial movement of the electric motor 10 relative to the outer ring 124 is limited in all directions. As a result, the clearance d2 illustrated in FIGS. 8d and 9b between the partitions 146 and the brushes 101 of the electric motor 10 can thus be reduced, which makes it possible to further contain the secondary air flow F2 around the brushes 101. The smaller the clearance d2, the less leakage there is of the secondary air flow F2. Thus, in one non-limitative example, the clearance d2 can be reduced from 5 mm to 1 mm. This thus increases the dissipation of the heat released by the brushes 101 by means of the secondary air flow F2. The brushes 101 are thus correctly cooled.
   In one non-limitative embodiment illustrated in FIGS. 10a and 10b, the fingers 1453 are connected to supports 1454 that make it possible to connect the fingers 1453 to the base 1452 of the motor cover 14 and that thus make it possible to control the position of the fingers 1453, which prevents:
said fingers 1453 from coming into contact with the studs 1220; and
said fingers 1453 from being too long and therefore breaking.

Of course, the description of the invention is not limited to the embodiments described above.

Thus, in another non-limitative embodiment not illustrated, the bowl 113 connecting the hub 117 to the blades 112 of the wheel 11 is open. In this case, it comprises openings to let through an incoming air flow F0, or arms. Thus, in another non-limitative embodiment not illustrated, the electric motor 10 does not include brushes 101 but windings.

The invention described thus particularly has the following advantages:
it makes it possible to confine the secondary air flow F2 around the brushes 101 of the electric motor 10;
it makes it possible to orient the secondary air flow F2 in the direction of the brushes 101 of the electric motor 10 so that the cooling of said brushes 101 is optimized; and
it makes it possible to reduce the relative movement between the movable parts (the electric motor 10) and the immovable parts (the motor cover 14) so as to avoid any breakage due to mechanical impacts during vibration resistance tests.

1. An air blower for a heating, ventilating and/or air conditioning device for a motor vehicle, the air blower comprising:
an electric motor comprising a drive shaft and brushes and on which a wheel is mounted,
said wheel being able to generate a main air flow in said heating, ventilating and/or air conditioning device; and
a motor support in which said electric motor is housed, the motor support comprising an air duct in which a secondary air flow originating from said main air flow is capable of circulating, said air duct comprising a first part and a second part, said second part comprising a curved shape so as to direct said secondary air flow onto said brushes of said electric motor.

2. The air blower as claimed in claim 1, wherein said second part has a cavity oriented in the direction of said motor support.

3. The air blower as claimed in claim 1, wherein said electric motor further comprises commutators, and said brushes are arranged in brush holders, wherein at least one of said brushes said brush holders and/or said commutators comprise openings.

4. The air blower as claimed in claim 1, wherein said second part comprises a tangent that forms an angle of between 45 degrees and 60 degrees with said drive shaft.

5. The air blower as claimed in claim 1, wherein said second part comprises a radial distance of between 61 and 82 millimeters.

6. The air blower as claimed in claim 5, wherein said second part further comprises a sharp edge at one of its ends.

7. The air blower as claimed in claim 1, wherein said motor support comprises:
a motor cover capable of covering said electric motor on the side opposite said wheel and defining said second part of said air duct;
a base capable of defining said first part of said air duct.

8. The air blower as claimed in claim 7, wherein said motor support further comprises partitions that extend from the motor cover in the direction of the brushes said electric motor.

9. The air blower as claimed in claim 8, wherein each partition is arranged near a brush of said electric motor.

10. The air blower as claimed in claim 7, further comprising:
a vibro-acoustic decoupling device comprising ribs,
wherein said motor cover comprises fingers capable of engaging with said ribs.

11. An air blower for a heating, ventilating and/or air conditioning device for a motor vehicle, the air blower comprising:
an electric motor comprising a drive shaft and brushes and on which a wheel is mounted,
wherein the wheel generates a main air flow in said heating, ventilating and/or air conditioning device; and
a motor support in which said electric motor is housed, the motor support comprising an air duct in which a secondary air flow originating from said main air flow is capable of circulating,
said air duct comprising a first part and a second part, said second part comprising a conic shape with a constant radius of curvature so as to direct said secondary air flow onto said brushes of said electric motor,
wherein the secondary air flow is contained close to the brushes so as to cool the brushes.

12. A method for operating an air blower for a heating, ventilating and/or air conditioning device (HVAC) for a motor vehicle, the method comprising:
generating a main air flow in said HVAC by a wheel mounted on an electric motor comprising a drive shaft and brushes; and
circulating a secondary air flow originating from said main air flow in an air duct of a motor support in which said electric motor is housed, said air duct comprising a first part and a second part; and
cooling the brushes of said electric motor with the secondary air flow by:
directing the secondary air flow onto the brushes using a shape of the second part, wherein the second part comprises a conic shape with a constant radius of curvature so as to direct said secondary air flow onto said brushes of said electric motor,
maintaining a constant velocity of the secondary air flow, and
containing the secondary airflow close to the brushes of the electric motor.
